(19) United States
(12) Patent Application Publication
(10) Pub. No.: US 2017/0240465 A1
(43) Pub. Date: Aug. 24, 2017

(54) METHOD FOR REMOVAL OF GRIT IN A SLAKER EQUIPPED WITH A GRIT COLLECTOR

(71) Applicant: Poju R. Stephansen AS, Borgen (NO)

(72) Inventor: Poju R. Stephansen, Borgen (NO)

(73) Assignee: Poju R. Stephansen AS, Borgen (NO)

(21) Appl. No.: 15/513,881

(22) PCT Filed: Sep. 30, 2015
(86) PCT No.: PCT/NO2015/050176

§ 371 Date: Mar. 23, 2017

(30) Foreign Application Priority Data
Sep. 30, 2014 (NO) 20141172

(51) Int. Cl. C04B 2/08; B01F 15/00; B01F 15/02; C04B 2/04; B01F 7/18

(52) U.S. Cl. CPC C04B 2/08; C04B 2/04; B01F 7/18; B01F 15/0292; B01F 15/00389; B01F 2215/0036

(57) ABSTRACT

Methods and a slaker for removal of heavy grit during batchwise slaking of burnt lime in a slaker (2) for the production of lime slurry with a high degree of fineness and prolonged sedimentation time are described, where the following processing steps are carried out during the slaking process: a)—reduction of the stirring of the slaker (2) from a normal stirring speed to a lower stirring speed, b)—opening of an upper inlet valve (60) in a collector (70) mounted in the lower part (54) of the slaker (2) to lead sinking grit in the slurry batch to the collector (70), whereupon the upper inlet valve (60) is closed after a given time period, c)—increase the stirring in the slaker (2) back to the normal stirring speed, d)—after a given time period with normal stirring speed, a regulating valve (22) in the lower part (54) of the slaker (2) is opened for emptying of a batch of slurry to an external storage tank (3), and e)—when said regulating valve (22) is opened for emptying of a batch of slurry, a lower outlet valve (62) in the collector is optionally opened for emptying of collected grit.

The present invention relates to a slaker and methods for batchwise slaking of burnt lime in a slaker, in which a lime slurry is produced with a greater degree of fineness and prolonged sedimentation time, as given in the introduction of the respective independent claims.

Lime slakers of different types, where most of them are intended for continuous operation, have been applied industrially for some time. “W+T” and “BJF” slakers can be referred to as examples.

U.S. patent application Ser. No. 45/47,349 relates to a device for non-batchwise, continuous slaking of lime. In UK patent application GB 2048107 A, a lime slaker is shown and described, also for non-batchwise, continuous operation. EP patent application 0510675 A3 relates to a lime slaker for non-batchwise, continuous operation. CA patent application 1212825 relates to a regulated process for batchwise production of slaked lime.

Furthermore, U.S. Pat. No. 7,105,146 B2 shows a method for batchwise slaking of lime which includes a flushing step before the subsequent slaking.

Lime slakers that are operated continuously have in common that they are difficult to control, very maintenance demanding, not suited to computer controlled operation and costly to manufacture.

In U.S. Pat. No. 5,746,983 a method is described for batchwise slaking, so-called “batch slaking” of burnt lime, also in relatively small amounts in relation to the volume of the slaker, whereupon a final product with relatively low lime concentration is obtained.

The content of the present application is a further development of U.S. Pat. No. 8,153,088 B2, previously submitted by the present applicant, and which is hereby incorporated by reference.

During operation of a lime slaker, impurities and dust can lead to build-up of limestone which influences the slaking and can lead to blowouts at too high temperatures. With the described slaker, in particular in connection with varying water temperatures in the slaker, the build-up of limestone and the disadvantages this leads to can be prevented.

A closed system is provided which does not produce dust, and due to the immediate cleaning and temperature regulation, an installation is provided with, at least, considerably reduced maintenance because of the reduction of the build-up of limestone.

In the slaking of CaO, there will normally be about 95% Ca(OH)2 and 5% so called grit, i.e. heavier gravel, hard particles etc. in the lime slurry. Grit is a serious problem in the advanced chemical process. Today there are several relatively complicated and costly processes that are placed after the slaker or in the pump tank/storage tank.

Consequently, it is an object of the present invention to provide a slaker and associated methods which, in a simple and reasonable way, can remove said grit from the slaker. As will be explained in more detail later, said grit is collected in connection with the slaker and can thereby be deposited somewhere else.

According to a first aspect of the invention, a method is provided for batchwise slaking of burnt lime in a slaker for the production of a lime slurry with a high degree of fineness and a prolonged sedimentation time, comprising the following process steps:
emptying of completely slaked and thinned lime slurry from the slaker until there is a predetermined weight of slurry left which is used for mixing into the next batch of slurry;
automatic connection of a control system that is used for automatic operation after the wanted slaking temperature of a first batch has been reached, that adds diluting water and thereafter burnt lime at a predetermined weight in the subsequent steps:
automatic regulation of the slaking temperature in the next volume of slurry where the ratio between water and lime is adjusted if the wanted slaking temperature was not reached in the previous batch, or exceeded, and where the slaker is filled completely with water to stop the slaking if the maximum temperature is exceeded, and
automatic registration of the remaining weight of slurry in the slaker after the dosing of the lime is completed, and the subsequent taring of a load cell unit to 0 kg before the next slaking, where, for the removal of heavier grit in the lime slurry, the following steps are carried out during the slaking process:
a)—reduction of the stirring in the slaker from a normal stirring speed to a lower stirring speed,
b)—opening of an upper inlet valve in a collector mounted to the lower part of the slaker to lead sinking grit in the slurry batch to the collector, whereupon the upper inlet valve is closed after a given time period.
c)—increase the stirring in the slaker back to the normal stirring speed,
d)—after a given time period with a normal stirring speed, a regulating valve in the lower part of the slaker is opened for emptying slurry batch to an external storage tank, and
e)—when said regulating valve is opened for the emptying slurry batch, a lower outlet valve in the collector is optionally opened for the emptying of the collected grit.

The steps a) to e) can be carried out when the slaker has been filled with diluting water and the water supply is closed.

In step a) the lower stirring speed can be set to between 1-10 Hz, preferably about 5 Hz, and a timer can be activated to regulate the time interval before the stirring speed is increased back to its normal stirring speed.

The regulating valve is preferably opened when it is verified from the external tank that there is room to receive a batch of slurry.

Furthermore, the lower outlet valve in the collector can be opened after a predetermined time each time the regulating valve is opened. Alternatively, the lower outlet valve in the collector is opened at optional intervals when the regulating valve is opened.

According to a second aspect of the invention, a method is provided for the removal of heavier grit during batchwise slaking of burnt lime in a slaker for the production of a lime slurry with a high degree of fineness and extended sedimentation time, where during the slaking process the following steps are carried out when the slaker is completely filled with diluting water and the water supply is closed:
b)—reduction of the stirring in the slaker from a normal stirring speed to a lower stirring speed,
b)—opening of an upper inlet valve in a collector mounted to the lower part of the slaker to lead sinking grit in the slurry batch to the collector, whereupon the upper inlet valve is closed after a given time period.
c)—increase the stirring in the slaker back to the normal stirring speed,
d)—after a given time period with a normal stirring speed, a regulating valve in the lower part of the slaker is opened for emptying slurry batch to an external storage tank, and
e)—when said regulating valve is opened for the emptying slurry batch, a lower outlet valve in the collector is optionally opened for the emptying of the collected grit.

The slaking process can be comprised of the following process steps:
emptying of fully slaked and diluted lime slurry from the slaker until there is a predetermined weight of slurry left that is used for mixing into the next slurry batch;
automatic coupling in of a control system for automatic operation after the wanted slaking temperature has been reached in the first batch, which adds dilution water and thereafter burnt lime at a predetermined weight in the subsequent steps;
automatic regulation of the slaking temperature in the next slurry batch, where the ratio between water and lime is adjusted if the wanted slaking temperature was not reached in the previous batch, or exceeded, and where the slaker is completely filled with water to interrupt the slaking if the maximum temperature is exceeded; and
automatic registration of the remaining weight of slurry in the slaker after completed dosing of lime, and subsequent taring of a load cell unit to 0 kg before the next slaking.

In step a) the lower stirring speed can be set to between 1-10 Hz, preferably about 5 Hz, and a timer can be activated to regulate the time interval before the stirring speed is increased back to the normal stirring speed.

The regulating valve is preferably opened when it is confirmed from the external tank that there is room to receive a batch of slurry.

The lower valve in the collector can be opened after a predetermined time, each time the regulating valve is opened. Alternatively, the lower valve in the collector can be opened at optional intervals when the regulating valve is opened.

According to a third aspect of the invention, a slaker is provided for batchwise slaking of burnt lime for the production of lime slurry, comprising a tank with an upper part and a lower conical part, equipped with a stirrer for stirring of a slurry batch comprised of lime and water, and also a regulating valve in the lower conical part of the slaker for emptying of the slurry batch to an external storage tank, and where the slaker comprises, or is connected to, means for controlling the process steps during the batchwise slaking of burnt lime, in which the lower conical part of the slaker comprises a centrally placed collector fitted with an upper inlet valve set up to open for sinking grit in the batch of slurry to the collector, and a lower outlet valve for emptying of collected grit from the collector.

The collector can be formed with an internal conical shape.

Furthermore, the upper inlet valve in the collector can be set up to open when the stirring speed is reduced from its normal speed to a lower stirring speed and to close after a predetermined time period.

The lower outlet valve in the collector for emptying of the collected grit can be set up to optionally open at given time intervals when said regulating valve is opened for the emptying of a batch of slurry.

The stirrer can extend down into the lower conical part of the slaker. Furthermore, the stirrer can comprise downwardly extending stirring parts, and also any stirring parts that extend in the horizontal direction.

The lower conical part of the slaker can be evenly tapering and end up at the collector.

The invention shall now be described with the help of the enclosed figures, in which

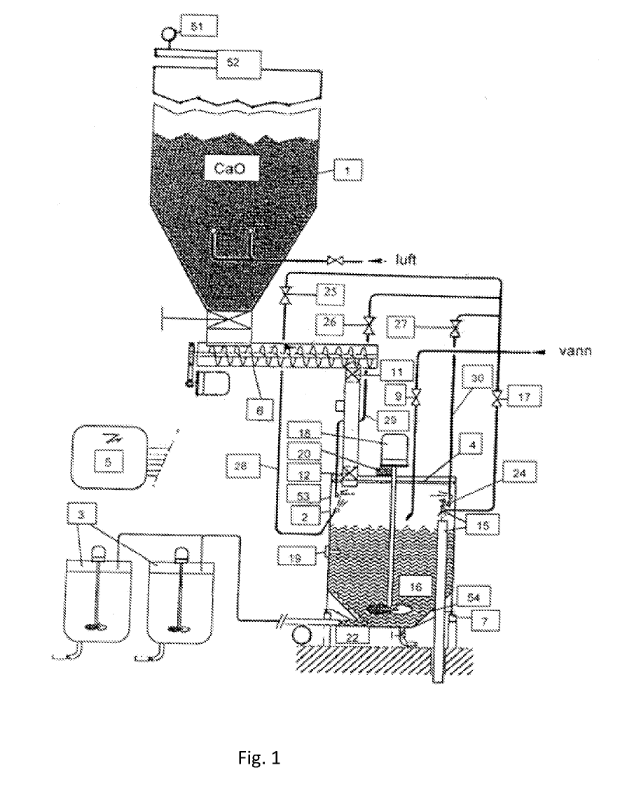

FIG. 1 shows a known solution of a lime slaking device.

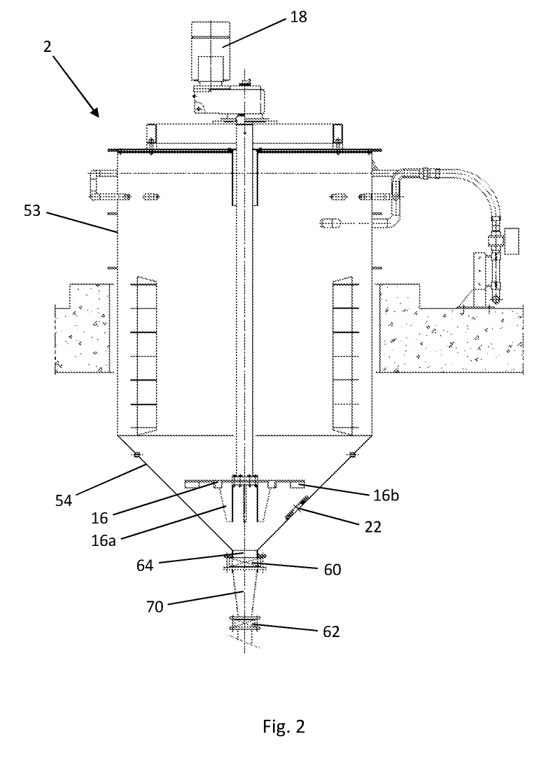

FIG. 2 shows a slaker according to the invention.

It shall be pointed out that the values given to weight, volumes, temperatures, times, etc. are given as examples and said values must therefore not be regarded as absolute.

An example of a known lime slaking device, which is shown schematically in FIG. 1, comprises of, in the main, a lime slaker 2 with a cylindrical top part 53 and a conical lower part 54 fitted on three load cells 7 for batchwise weighing of water and lime and with a stirrer 16 with a specially constructed mixing body and drive motor 18, rotation monitor 20 and also a water-jet driven combined dust suction/weir appliance/baffle 15 that is supplied water through a pipeline with a valve 17, where the slaker 2 receives water through a pipeline with valves 9. The slaker lid 4 is connected to a specially constructed water-outflow-preventing valve that also separates the wet and the dry lime zones. The slaker is connected to a lime silo 1 with a level gauge and also a filter 52 with a drive motor 51 for mechanical cleaning. The silo may hold 80 tonnes of burnt lime, for example, of volumetric weight 1.1 (weight scale range 0-90 tonnes), and is equipped with load cells to read the weight. The load cells' amplifier gives out a 4-20 mA signal to a PLS. The silo can also be fitted with three air activators that are started and follow a given cycle if the dosing time for the screw transporter is exceeded.

Through a blowing-in pipe, the silo is filled with lime from, for example, a tanker. The weight of lime in the slaker is given from a cabinet at the silo filling station. When 95% of the weight has been reached (AH) an alarm in the form of an audio/light signal alerting that the filling must be stopped is given. The audio alarm can be stopped from the cabinet and/or automatically by PLS, for example, after three minutes. At 100% weight (AHH) a filling valve is automatically closed and the blowing-in of lime stops. While the valve is closed, a red warning lamp in the cabinet indicates that no filling of the silo can occur.

The filling valve can be controlled manually from a panel in the control centre.

The reference number 5 shows illustratively the necessary logic, control processes and control signal, etc., to control and operate the slaking process in the slaker.

Load cells fitted on the silo emit an alarm signal and a trip signal:
at ≧AH Alarm. The operator is warned about a high level in the silo.
at ≧AHH Warns the operator and shuts the inlet valve.
at ≦ALZ Alarm. Low level in the silo.

The filter motor is preferably fitted with a safety switch and a service reverser (automatic/manual).

After the filling of lime in the silo has been completed, the filter motor 51 is started manually from a local cabinet. A signal is emitted from the cabinet to an outer PLS that starts the filter motor and monitors the operational state of the motor. The filter motor 51 stops automatically after three minutes.

### EXAMPLE

1. Start button in a local cabinet is activated
2. Filter motor 51 starts and the operation light in the cabinet lights up
3. The filter motor stops after about three minutes

Lime is transferred with the screw transporter 6 from the silo 1 to the slaker 2 with the valves 11 and 12 open. The slaking is initiated in that the first batch is slaked manually. The addition of lime is thereafter automatic, whereby the slaker 2 is filled with a predetermined amount of diluting water. The slaker is thereafter emptied to a predetermined residual amount, into which the next batch of lime is to be slaked.

The lime slaking temperature is decided by the ratio between residual number of kilos diluted lime slurry in the slaker (EVL) and the number of kilos of added lime (EVH), or the chosen set-points on the load cells 7, i.e. the set-points on the scale one chooses. The concentration of fully slaked lime is determined finally by the number of kilos of water that is chosen at the last set-point (EVHH). The number of kilos of water that is chosen at the last set-point (EVHH) is determining for the concentration of fully slaked lime.

The load cells 7 generate five working contacts for use in sequence:
at ≧EVHHH Filling of water to the upper level.
at ≧EVHH Reached amount of filled flushing water.
at ≧EVH Reached amount of added lime.
at ≧EVL New slaking level confirmed before new slaking.
at ≧EVLL Stirring is stopped.

Fully slaked lime is sent to a storage tank/pumping tank 3 through the valve 22 with the help of a motor. The motor is preferably fitted with a safety switch and a service reverser.

The subsequent first example shows a known slaker with an operating volume of, for example, 2100 litres (weight scale area 0-2500 kg). At the start, the slaker 2 is manually filled with 400 litres of water, followed by 120 kg lime under stirring. When the mixture has reached a stable temperature of about 80° C., registered by a temperature measuring element 19, automatic operation can start and water is added to a mixture weight of 1200 kg, which gives a10% slurry with a temperature of about 30° C. The slaker can now be emptied to a remaining weight of, for example, 600 kg. This is followed by a break of 30 seconds for return from, for example, the pump. It is important that the control system can register the real value of the batch and is tared to 0 kg, which is necessary because inertia in the system can lead to a risk of more or less chemicals than predetermined being added to the slaker.

With automatic control, when the weight in the slaker 2 is 600 kg or a newly calculated value based on the temperature regulation and after a pause of 30 seconds has expired, the slaking process will start if it is not already underway and the valve 22 will be closed.

The butterfly valve 12 in the slaker lid receives an opening signal and is confirmed in an open position from limit switches, the opening signal is sent over to the valve 17, and a dust suction unit 15 is started. After five seconds time delay the valve 11 is opened at the outflow end of the screw transporter 6 and is confirmed as open from a limit switch. A rotation monitor controls that the stirring has begun and an alarm is given if this is not the case or if the valve is not open after the command. If stirring stops, the valve 9 is opened and the slaker is completely filled with water and the process is interrupted.

The screw transporter 6 is started five seconds after a limit switch has confirmed that valve 11 is in an open position, and initiates the timer for normal dosing time, for example, 180 seconds. The correct dosing time is set at start up of the plant. If the time is exceeded by 100% (360 seconds in this example), the air stimulator will be opened and closed in a determined cycle (open for about 0.5 seconds for every 30 seconds) with a start in the pause part and limited to 180 seconds. If the predetermined weight in the mixer is still not achieved the cycle will be interrupted because the storage tank signals a low level and an alarm is given.

The screw transporter 6 is kept going until the required lime amount (120 kg) has been weighed-in. One second after the transporter has stopped the valve 11 is closed. Ten seconds after the valve is confirmed as closed, a solenoid valve is opened for three seconds for air to the outflow vibrator. The valve 12 is closed for 20 seconds after the valve 11 is confirmed as closed, and a limit switch controls that the valve is closed. When the valve has closed, the weight is recalibrated to 0 kg. An alarm is sounded if the valve is not closed after the command.

For immediate cleaning of the slaker 2 before the next slaking, after said taring of the load cell installation 7, a number of valves can be opened for a fixed period of time for supply of flushing water to the respective nozzles, in that the flushing water is supplied sequentially via each valve to associated nozzles(s) until a predetermined amount of flushing water is reached in the slaker 2. For example, five seconds after the valve in the slaker 2 has signalled closed and after the finished slaking, the first valve 25 is opened for flushing water with a nozzle for ten seconds, after which the first valve 25 is closed and the second valve 26 is opened for flushing water with three nozzles for eight seconds, after which the second valve 26 is closed and the third valve 27 is opened for flushing water with three nozzles on the opposite side of the slaker 2, until a total predetermined amount of flushing water has been weighed into the slaker. Flushing water is supplied until the total amount of flushing water weighed in is, for example, 20 kg.

As shown in FIG. 1, the first valve 25 controls the delivery of water to one or more nozzles via a pipe 28, while the second valve controls delivery of water to one or more nozzles via a pipeline 29, and the third valve 27 controls delivery of water to one or more nozzles via a pipeline 30. Preferably, nozzles are placed on opposite sides in the slaker, for example, the nozzles can be placed in one half of the circumference or the whole of the circumference of the slaker, for example, with the same or different mutual spacing.

20 seconds after valve 12 is closed, the closing signal is given to valve 17 and the dust suction 15 is stopped. After the screw transporter is stopped, adjustable slaking time is begun, for example, ten minutes. The chosen slaking time and the course of this should be indicated to the operator.

When the slaking time is finished, water is supplied through the flushing nozzles 24 for 15 seconds. Thereafter 1180 kg of diluting water (calculated from the second 0-taring which has already added 20 kg of water) is supplied through the valve 9, which gives a 10% lime slurry at a temperature of 30° C. With an error in amount of lime added above +2% the amount of diluting water is adjusted.

The temperature in the slaker is monitored by a temperature measuring element. If a temperature of 83° C. is not reached during the slaking process, 15 kg more of the finished slurry is emptied out, whereby EVLL reduces to 485 kg or conversely if the temperature is too high (88° C.) to 515 kg.

If the temperature during the slaking process rises above 96° C., it is opened for filling with water to the full level EVHHH, the process is interrupted and an alarm is given, without the stirring being stopped.

As previously described, for preparation of a10% lime slurry it is required to add 60 kg of lime and 600 kg of water. The total level will vary depending on the temperature regulation. The finished concentration of the lime slurry is determining for the temperature of the slurry into which the lime is added for the next slaking. If a lime slurry with a higher concentration is wanted, the slaking should take place at a higher initial temperature. If a lower concentration is required at, for example, the point of use, the slurry should be diluted outside the slaker, for example, by proportional dosing between water and lime solution in the pipeline after the storage tank. Addition of water can be regulated with a flow meter and a control valve. Alternatively, measured amounts of water can be added in the storage tank at the same time as the slaker, from full weight in smaller batches, for example, four, adds proportional lime slurry amounts in the storage tank.

After completed slaking time the level in the storage tank 3 is controlled, and when this is reduced to EVLL, valve 22 is opened and the batch is emptied into the storage tank.

In a second example a slaker with a capacity of, for example, 4000 kg is used. It shall be described in connection with a such slaker how the temperature control can be carried out in several phases depending on the inlet water temperature. The finished amounts of more or less of the finished slurry which is emptied out of the slaker and the amount of more or less of the flushing water or diluting water which is added to the slaker will thus be regulated dependent on the capacity of the slaker.

At water temperatures between 0-10° C. the temperature can be regulated in that a pre-determined amount more of the finished slurry is emptied out if a lower temperature limit is not reached, and if the temperature during slaking goes above an upper temperature limit a pre-determined smaller amount of the finished slurry is emptied out. In a slaker 2 with capacity of 4000 kg , 50 kg more of the finished slurry can be emptied out if a lower temperature limit of 79° C. is not reached, and if the temperature during slaking goes above an upper temperature limit of 86° C., 50 kg less of the finished slurry can be emptied out.

At water temperatures between 10-20° C. the temperature is regulated in that more of a pre-determined amount of flushing water or diluting water is supplied if the lower temperature limit is not reached, and if the temperature during slaking goes above an upper temperature limit less of a pre-determined amount of flushing water or diluting water is supplied. Correspondingly in a slaker 2 with capacity of 4000 kg the temperature is regulated in the second phase in that 50 kg more of flushing water or diluting water is supplied if the lower temperature limit of 79° C. is not reached, and if the temperature during slaking goes above an upper temperature limit of 86° C., 50 kg less flushing water or diluting water is added.

The second phase with more or less added flushing water or diluting water is activated, for example, when the first phase has regulated the emptying level up a pre-determined number of times, such as EVL five times up.

Correspondingly, as explained in the first example, if the temperature in phase one or phase two sometimes goes above 96° C. in the course of the process, the valves are opened and the slaker is filled with water to (EVHHH) the full level and the process is stopped with the subsequent equipment alarm. The stirrer must not be stopped.

Finished lime slurry is temporarily stored in the storage tanks 3 which are equipped with a level measure in the form of a pressure transmitter and also stirrer(s). The tank can generate signals for regulation of the slaking sequence. The level signal generates two working contacts for use in the sequence and also two signals for an alarm at low and high level, respectively, and a signal for starting of the pumps.
at ≧EVL: Slaking can be initiated.
at ≧EVLL: Signal for receipt of a new batch from slaker.
at ≧AHH: Alarm, for high level. Valve is closed.
at ≧AL: Alarm, for low level.
at ≧ALL: Alarm, very low level. Pumping out from storage tank 3 is stopped.

The stirrer shall be operated continuously and is monitored by PLS. An alarm is given in addition to stop.

For the dosing of the slurry, one or more pumps are used. The pumps are arranged “standby” for each other and can be reset manually. Sealing water is added to the packing boxes of the pumps through solenoid valves, which have inbuilt flow switches for discharge of water if the sealing water does not appear for more than three minutes after start, an alarm is given and the pumps stop. The same will happen if sealing water is absent for three minutes during operation. Additionally, each pump is equipped with a flow detector and a pressure sensor which is fitted in the pipe on the pressure side of the pumps. If these do not register an amount of water and pressure after 15 seconds, an alarm is given. If the amount of water and the pressure are absent for a further 15 seconds, the pumps stop. A flow meter is used to measure the amount of slurry from the storage tank to the sand filter. This measuring unit sends a 4-20 mA signal back to the frequency converter(s).

In the two examples given above that describe slakers with a capacity of 2100 kg and 4000 kg, respectively, the normal slaking range lies between 75° C. and 90° C. Therefore the given temperatures must not be regarded as absolute, but be regarded as examples so that for slakers in the embodiment examples and other slakers with a different capacity, the temperatures can vary according to the circumstances.

FIG. 2 describes a slaker according to the invention. The slaker is essentially reconstructed with regard to the known slaker shown in FIG. 1. The slaker in FIG. 2 is given the reference number 2 as it will be part of a system that is described with regard to FIG. 1 above, and will be able to have the same function and processes that are described above. The corresponding is the case for other parts shown in FIG. 2.

The slaker 2 is equipped a smaller collecting cone or collector to remove the heavier grit in the lime slurry. This sequence can be activated or deactivated. When active the sequence starts when the slaker is completely filled with diluting water and the water valve is closed.

As shown in FIG. 2, the slaker comprises, in a corresponding way, an upper part 53 and a lower conical part 54, and a stirrer 16 is arranged inside the slaker 2 driven by a motor 18. In the side surface of the lower conical part 54, a regulating valve 22 is arranged in an outlet for emptying of finished slaked lime slurry. The finished slaked lime slurry that is emptied out is led on to a pump tank/storage tank 3, as shown in FIG. 1.

For the collecting of grit, i.e. heavier gravel and the like in the lime slurry, a collector 70 is preferably mounted centrally underneath the conical part 54. The lower conical part 54 is evenly tapered and consequently ends up at the collector 70. As can be seen in FIG. 1, the lower part of the known slaker is fitted with a lower flat section and does not run evenly tapered all the way down to the collector as in the present invention.

The collector 70 can also have a downwardly facing conical form, both internally and externally. Internally will be particularly appropriate with the largest inlet area uppermost and the smaller outlet area at the bottom. The collector 70 is as shown mounted to a central outlet 64 in the lower part 54 of the slaker and is equipped with an upper inlet valve 60 to regulate the inflow of grit to the collector 70. The upper inlet valve 60 can naturally also be mounted in the outlet 64 or between the outlet 64 and the collector 70. Furthermore, the collector 70 is equipped with a lower outlet valve 62 to regulate the outflow of grit from the collector 70 to, for example, an external container or the like.

During the slaking process, when the slaker 2 is completely filled with diluting water and the water valve is closed, the stirring in the slaker 2 is reduced from a normal stirring speed to a lower stirring speed. The revolutions of the stirrer 16 can be reduced down to, for example, between 1-10 Hz, preferably about 5 Hz. Furthermore, a timer is activated for, for example, 1-5 minutes to regulate the duration of the lower stirring speed.

The upper inlet valve 60 in the collector 70 mounted to the lower part 54 of the slaker 2 is opened to lead sinking grit in the batch of slurry to the collector 70, whereupon the upper inlet valve 60 is closed after a given time period. This time period can correspond with, or be controlled by, a corresponding timer that controls the stirring speed.

Thereafter, the stirring of the slaker 2 is increased back to the normal stirring speed in that the frequency control of the stirrer 16 increases the rotations back to the original. After a given time period with the normal stirring speed, the regulating valve 22 in the lower part 54 of the slaker 2 is opened for emptying of a batch of slurry to an external storage tank 3 or the like. It will be an advantage that the regulating valve 22 is first opened when it is confirmed from the external storage tank/pump tank 3 that there is room to receive more slurry in the tank. The storage tank can possibly be omitted and the slurry can go directly to a water plant or the like.

When the regulating valve 22 is opened for emptying of a batch of slurry, the lower outlet valve 62 in the collector 70 is opened for the emptying of collected grit. The lower outlet valve 62 can open after a predetermined time every time, or every other, third or fourth time, etc., the regulating valve 22 opens.

Collected grit can be emptied out into a container or the like. The valve closes after, for example, one minute.

The sedimentation time of grit can be a part of determining the above given time intervals for the stirring speeds and closing/opening times. Such sedimentation times can be found in tables and, by the use of the control units of the system, the time intervals can be set independently of the composition of the batch of slurry and any particular temperature.

The outlet valve 62 of the collector 70 is opened after the inlet valve 60 has shut. This can also be carried out independently of the opening of the regulating valve 22, if required by circumstances.

The stirrer 16 protrudes or extends preferably down in the conical part 54 of the slaker, as shown in FIG. 2. Furthermore, the stirrer 16 can be composed of downwardly extending stirrer parts 16, that extend down in a tapering fashion towards the bottom of the lower part 54, and also the stirrer part 16b that extends in a horizontal direction.

The inlet valve 60 and the outlet valve 62 can be formed as plate valves. As the sinking grit normally has a mud-like consistency, butterfly vales, for example, will not be suitable, but it should not be excluded that such valves or similar valves can be used.

1. Method for batchwise slaking of burnt lime in a slaker (2), for the production of lime slurry with a high degree of fineness and prolonged sedimentation time, comprising the following processing steps:
emptying of finished slaked and diluted lime slurry from the slaker (2), until there is a predetermined slurry weight left, which is used for mixing with the next slurry batch;
automatic coupling of a control system for automatic operation after the wanted slaking temperature has been reached in the first batch, which adds diluting water and thereafter burnt lime at a predetermined weight in the subsequent steps;
automatic regulation of the slaking temperature in the subsequent batch of slurry, where the ratio between water and lime is adjusted if the wanted slaking temperature was not reached or exceeded in the previous batch, and where the slaker (2) is completely filled with water to stop the slaking if the given maximum temperature is exceeded; and
automatic registering of the remaining slurry weight in the slaker after complete dosing of lime and subsequent taring of a load cell unit (7) to 0 kg before the next slaking, characterised in that for the removal of heavier grit in the lime slurry the following steps are carried out during the slaking process:
a)—reduction of the stirring of the slaker (2) from a normal stirring speed to a lower stirring speed,
b)—opening of an upper inlet valve (60) in a collector (70) mounted in the lower part (54) of the slaker (2) to lead sinking grit in the slurry batch to the collector (70), whereupon the upper inlet valve (60) is closed after a given time period,
c)—increase the stirring in the slaker (2) back to the normal stirring speed,
d)—after a given time period with normal stirring speed, a regulating valve (22) in the lower part (54) of the slaker (2) is opened for emptying of slurry batch to an external storage tank (3), and
e)—when said regulating valve (22) is opened for emptying of a batch of slurry, a lower outlet valve (62) in the collector (70) is optionally opened for emptying of collected grit.

2. Method according to claim 1, characterised in that the steps a) to e) are carried out when the slaker (2) is completely filled with diluting water and the water supply is closed.

3. Method according to claim 1, characterised in that the regulating valve (22) in step d) is opened when it is confirmed from the external tank (3) that there is room for the receipt of a batch of slurry.

4. Method according to claim 1, characterised in that the lower stirring speed is set in step a) to between 1-10 Hz, preferably about 5 Hz, and that a timer is activated to regulate the time interval before the stirring speed is increased back to a normal stirring speed.

5. Method according to claim 1, characterised in that the lower outlet valve (62) in the collector (70) is opened after a predetermined time every time the regulating valve (22) is opened.

6. Method according to claim 1, characterised in that the lower outlet valve (62) in the collector (70) is opened at optional intervals when the regulating valve (22) is opened.

7. Method for the removal of heavier grit during batchwise slaking of burnt lime in a slaker (2) for the production of a lime slurry with a high degree of fineness and extended sedimentation time, characterised in that during the slaking process the following steps are carried out when the slaker (2) is completely filled with diluting water and the water supply is closed:
a)—reduction of the stirring of the slaker (2) from a normal stirring speed to a lower stirring speed,
b)—opening of an upper inlet valve (60) in a collector (70) mounted to the lower part (54) of the slaker (2) to lead sinking grit in the slurry batch to the collector (70), whereupon the upper inlet valve (60) is closed after a given time period,
c)—increase the stirring in the slaker (2) back to a normal stirrer speed,
d)—after a given time period with normal stirring speed, a regulating valve (22) in the lower part (54) of the slaker (2) is opened for emptying of a batch of slurry to an external storage tank (3), and
e)—when said regulating valve (22) is opened for emptying of a batch of slurry, a lower outlet valve (62) in the collector (70) is optionally opened for emptying of collected grit.

8. Method according to claim 7, characterised in that the slaking process is comprised of the following process steps:
emptying of finished slaked and diluted lime slurry from the slaker (2), until there is a predetermined slurry weight left, which is used for mixing with the next slurry batch;
automatic coupling of a control system for automatic operation after the wanted slaking temperature has been reached in the first batch, which adds diluting water and thereafter burnt lime in a predetermined weight amount in the subsequent steps;
automatic regulation of the slaking temperature in the subsequent batch of slurry, where the ratio between water and lime is adjusted if the wanted slaking temperature was not reached or exceeded in the previous batch and where the slaker (2) is completely filled with water to stop the slaking if the maximum temperature is exceeded; and
automatic registering of the remaining weight of slurry in the slaker after complete dosing of lime and subsequent taring of a load cell unit (7) to 0 kg before the next slaking.

9. Method according to claim 7, characterised in that the lower stirring speed is set in step a) to between 1-10 Hz, preferably about 5 Hz, and that a timer is activated to regulate the time interval before the stirring speed is increased back to a normal stirring speed.

10. Method according to claim 7, characterised in that the regulating valve (22) in step d) is opened when it is confirmed from the external tank (3) that there is room to receive a batch of slurry.

11. Method according to claim 7, characterised in that the lower valve (62) in the collector (70) is opened after a predetermined time every time the regulating valve (22) is opened.

12. Method according to claim 7, characterised in that the lower valve (62) in the collector (70) is opened at optional intervals when the regulating valve (22) is opened.

13. Slaker (2) for batchwise slaking of burnt lime for the production of lime slurry, comprising a tank with an upper part (53) and a lower conical part (54) equipped with a stirrer (16) for stirring of a batch of slurry comprised of lime and water, and also a regulating valve (22) in the lower conical part (54) of the slaker (2) for emptying of a batch of slurry to an external storage tank (3), and that the slaker (2) comprises, or is connected to, means to control the process steps during the batchwise slaking of burnt lime, characterised in that the lower conical part (54) of the slaker (2) comprises a centrally placed collector (70) that is equipped with an upper inlet valve (60) arranged to open for the sinking grit in the slurry to the collector (70) during the slaking process, and a lower outlet valve (62) for emptying of collected grit from the collector (70).

14. Slaker (2) according to claim 13, characterised in that the collector (70) is formed internally in a conical shape.

15. Slaker (2) according to claim 13, characterised in that the upper inlet valve (60) in the collector (70) is arranged to open when the stirrer (16) reduces its stirring speed from a normal speed to a lower stirring speed and to close after a predetermined time period.

16. Slaker (2) according to claim 13, characterised in that the lower outlet valve (62) in the collector (70) for emptying of collected grit is arranged to optionally open at given intervals when said regulating valve (22) is opened for emptying of a batch of slurry.

17. Slaker (2) according to claim 13, characterised in that the stirrer (16) extends down into the lower conical part (54) of the slaker (2).

18. Slaker (2) according to claim 13, characterised in that the stirrer (16) comprises downwardly extending stirring parts (16a), and also any stirrer parts (16b) that extend in the horizontal direction.

19. Slaker (2) according to claim 13, characterised in that the lower conical part (54) of the slaker (2) is tapered evenly and ends up at the collector (70).
